(19) United States
(12) Patent Application Publication
(10) Pub. No.: US 2025/0093651 A1
(43) Pub. Date: Mar. 20, 2025

(54) PROJECTION DEVICE AND PROJECTION METHOD

(71) Applicant: Carl Zeiss Jena GmbH, Jena (DE)

(72) Inventor: Daniel THOMAE, Jena (DE)

(21) Appl. No.: 18/293,340

(22) PCT Filed: Jul. 22, 2022
(86) PCT No.: PCT/EP2022/070615

§ 371 Date: Jan. 29, 2024

(30) Foreign Application Priority Data
Jul. 30, 2021 (DE) 10 2021 119 886.0

(51) Int. Cl. G02B 27/01

(52) U.S. Cl. CPC G02B 27/0172; G02B 2027/0112; G02B 2027/0174; G02B 2027/0178

(57) ABSTRACT

An imaging module of a projection device generates a multi-color image such that a first color sub-image with a first wavelength and a second color sub-image with a second wavelength are generated. Deflection efficiency curves for a specified angular range about a specified viewing angle are set such that a first efficiency ratio for the specified angular range is constant. The imaging module is actuated such that when the multi-color image is generated, a first brightness ratio of the brightness of the first color sub-image to the brightness of the second color sub-image is inversely proportional to the a efficiency ratio such that different deflection efficiency curves are compensated for and such that the viewer can perceive the multi-color image as a true-color virtual image at viewing angles from the specified angular range.

### PRIORITY

This application claims the priority of German patent application DE 10 2021 119 886.0 filed Jul. 30, 2021, which is hereby incorporated herein by reference in its entirety.

### FIELD

The present invention relates to a holographic projection device and to a holographic projection method.

### BACKGROUND

In the case of such a holographic projection device, a volume hologram can be used for deflecting the image to be imaged. Since the deflection efficiency of such volume holograms varies for different wavelengths depending on the viewing angle for a user, this may disadvantageously have the effect that the projected image has an undesirable color cast toward the edge, and this color cast very quickly becomes conspicuous to an observer and is very disturbing. Three wavelengths are generally used in a projection unit, with a respective wavelength for blue, green and red generally being provided. However, it is also possible for only two wavelengths to be used.

### SUMMARY

An object of the invention to provide a projection device in which this difficulty is eliminated as far as possible. Furthermore, the intention is to provide a corresponding projection method.

Since the image module in the projection device is controlled such that when the multicolored image is generated, a first brightness ratio of the brightness of the first color sub-image to the brightness of the second color sub-image is inversely proportional to the first efficiency ratio, the different deflection efficiency profiles are thus compensated for and the observer can perceive the multicolored image as a true-color virtual image for viewing angles from the predetermined angular range. An opposite color cast is generated during the image generation, therefore, which is present on the basis of the volume gratings of the volume hologram for the deflection. This is possible since the deflection efficiency profiles for the predetermined angular range around the predetermined viewing angle are set such that the first efficiency ratio for the predetermined angular range is constant.

It can also be stated, therefore, that the different viewing-angle-dependent deflection efficiency profiles of the volume hologram for different wavelengths are set such that the first efficiency ratio for the predetermined angular range is constant. At the same time, the brightness at the image module for the first and second color sub-images is set such that the first brightness ratio is inversely proportional to the first efficiency ratio for the predetermined angular range.

Consequently, no undesirable color cast occurs for viewing angles within the predetermined angular range.

The volume gratings can be reflective or transmissive gratings. Likewise, in the case of an image waveguide the volume gratings can also be edge-lit gratings.

Furthermore, the volume gratings can advantageously be formed in the same layer, which is also referred to as multiplexing. The volume gratings can thus easily be produced in a simple manner.

Of course, it is also possible to provide a separate layer for each volume grating. These layers are then preferably mounted one on top of another.

The volume gratings can be volume gratings introduced by exposure, for example. That is preferably understood here to mean that the volume grating is exposed and optionally developed or bleached, such that a stable volume grating introduced by exposure is then present.

The exposure for producing the volume grating introduced by exposure can be carried out for example such that a reference wave having a predetermined wavelength (e.g. 532 nm, 460 nm or 640 nm) is directed at a first angle of incidence (e.g. of) 0° onto a layer (which comprises or is formed from a photosensitive volume-holographic material) into which the volume grating is intended to be introduced by exposure, and that a signal wave having the same wavelength is likewise directed onto the layer at a second angle of incidence (e.g. of) 60°, which differs from the first angle of incidence, the reference wave and the signal wave originating from the same laser such that an interference field or interference volume having the desired number of interference maxima arises over the photosensitive volume-holographic material of the layer and a desired refractive index modulation is thus formed. The refractive index change produced is maximal at the interference maxima, such that the interference maxima define the refractive index modulation.

By way of example, photosensitive glasses, dichromate gelatins or photopolymers can be used as photosensitive volume-holographic materials. They can e.g. be applied to a PC film (polycarbonate film) and be correspondingly exposed there.

The refractive index modulation is understood here to mean in particular the absolute value of the maximal refractive index change or variation.

The volume hologram can be embedded in a transparent carrier. However, it is also possible for the volume hologram to be formed in the interface of the transparent carrier.

The transparent carrier can also be used as an image waveguide having an input coupling region spaced apart from the volume hologram, the multicolored image being coupled into the image waveguide via said input coupling region. In the image waveguide, the multicolored image can be guided by reflections as far as the volume hologram. The volume hologram then couples out the guided light to the observer.

The transparent carrier can be for example a windshield or some other window of a vehicle. However, a plane-parallel plate can also be involved. Furthermore, it is possible for the transparent carrier to have curved interfaces. The transparent carrier of the volume hologram can also be part of an optical system which e.g. is arranged in the dashboard of a vehicle and from there directs the light to the observer by way of the reflection at the windshield.

The transparent carrier can be produced from glass or from plastic.

In particular, the projection device can be configured such that the generated virtual image is perceptible in a manner superimposed with the surroundings. For this purpose, the volume hologram is preferably also transmissive to the first and second wavelengths.

The predetermined angular range can be an angular range of 2°, 3°, 4°, 5°, 6°, 7°, 8°, 9°, 10°, 11°, 12°, 13°, 14°, 15°, 16°, 17°, 18°, 19° or 20°. The predetermined angular range can be different in horizontal and vertical directions. In this regard, e.g. the horizontal angle can be 14°-20° and the vertical angle can be 5°-7.5°. The predetermined viewing angle can lie in the center of the predetermined angular range. However, it can also lie outside the center of the predetermined angular range.

A constant efficiency ratio for the predetermined angular range is understood here to mean in particular that the efficiency ratio for the predetermined angular range changes between the wavelengths (preferably relative to the maximal value of the efficiency ratio in the predetermined angular range) by not more than 1%, 2%, 3%, 4%, 5%, 6%, 7%, 8%, 9%, 10%, 11%, 12%, 13%, 14%, 15%, 16% or 17%.

It goes without saying that the features mentioned above and the features yet to be explained hereinafter can be used not only in the specified combinations but also in other combinations or on their own, without departing from the scope of the present invention.

The invention will be explained in even greater detail below on the basis of exemplary embodiments with reference to the accompanying drawings, which likewise disclose features essential to the invention. These exemplary embodiments are provided for illustration only and should not be construed as limiting. For example, a description of an exemplary embodiment having a multiplicity of elements or components should not be construed as meaning that all of these elements or components are necessary for implementation. Rather, other exemplary embodiments may also contain alternative elements and components, fewer elements or components, or additional elements or components. Elements or components of different exemplary embodiments can be combined with one another, unless stated otherwise. Modifications and variations that are described for one of the exemplary embodiments can also be applicable to other exemplary embodiments. In order to avoid repetition, elements that are the same or correspond to one another in different figures are denoted by the same reference signs and are not explained repeatedly.

### BRIEF DESCRIPTION OF THE DRAWINGS

FIG. 1 shows a schematic view of a first embodiment of the holographic projection device;

FIG. 2 shows an enlarged detail illustration of the projection device from FIG. 1;

FIG. 3 shows an illustration of the deflection efficiency of the volume gratings for three different wavelengths;

FIG. 4 shows an illustration of the effective deflection efficiency taking account of the brightness scaling of the image generator for the wavelengths from FIG. 3;

FIG. 5 shows a further embodiment of the holographic projection device;

FIG. 6 shows a further embodiment of the holographic projection device;

FIG. 7 shows a further embodiment of the holographic projection device, and

FIG. 8 shows a partial sectional view of the projection device from FIG. 7.

### DETAILED DESCRIPTION

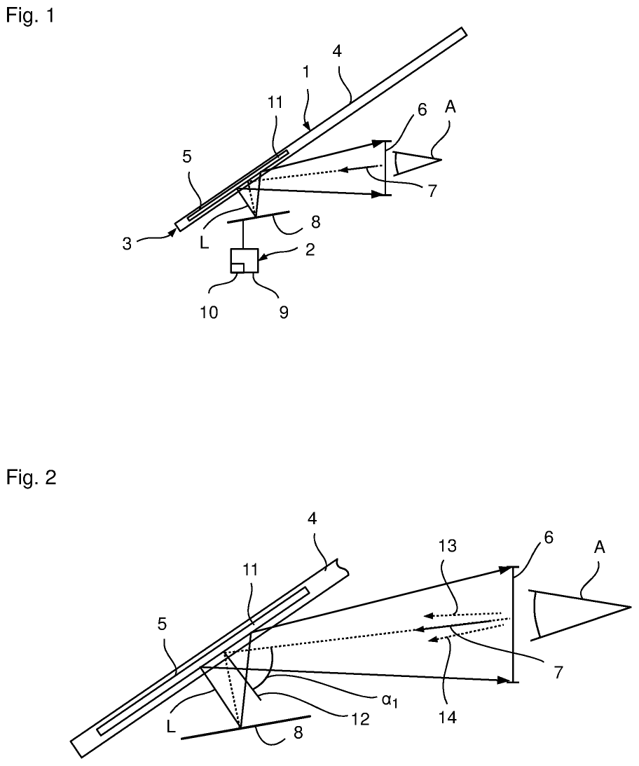

In the embodiment shown in FIG. 1, the holographic projection device 1 comprises an image module 2 for generating a multicolored image and a projection unit 3, which in this case comprises a holographic beam splitter 5, integrated into a windshield 4 of a vehicle, at which the multicolored image (the beam path of a light beam L is depicted as representative) is deflected in the direction of an exit pupil 6 of the projection unit 3 such that a user who positions their eye A in the exit pupil 6 can perceive the multicolored image as a virtual image when they look along a predetermined viewing direction 7 at the projection unit 3 (or in this case at the holographic beam splitter 5).

The image module 2 can comprise an image generator 8 and a control unit 9 having a processor 10, wherein the control unit 9 controls the image generator 8 for generating the multicolored image. The image generator 8 can be an LCD module, an OLED module, an LCoS module, or a tilt mirror matrix. Furthermore, the image generator can comprise a diffusing plate, which is not depicted here. The system can likewise have a light source, such as e.g. lasers, which is not directly assigned to the image generator and serves to illuminate the image generator, which light source is not depicted.

The multicolored image is generated by means of the image generator 8 in that, for example, three color sub-images having different wavelengths are generated. For example, they can be a blue color sub-image having a wavelength of 460 nm, a green color sub-image having a wavelength of 532 nm, and a red color sub-image having a wavelength of 640 nm. The color sub-images can be generated simultaneously or alternately in temporal succession so quickly that only the superimposition is perceptible as a multicolored image for a user.

As is evident in particular in the enlarged partial view in FIG. 2, the holographic beam splitter 5 comprises a photopolymer layer 11, in which a volume-holographic grating is written for each of the three wavelengths. The three gratings are thus superimposed in the same volume (specifically in the photopolymer layer 11), such that so-called multiplexing is present. Each of the three volume-holographic gratings is configured such that it is reflective for one of the three wavelengths mentioned (for example, with a bandwidth of +3% of the central wavelength) and transmits the remaining wavelengths. In this case, the reflection should be understood as diffraction at the grating structure of the volume hologram. In this case, the reflectivity of the individual volume-holographic gratings, which corresponds to the diffraction efficiency, as will also be described in detail hereinafter, is set such that an effective reflectivity of approximately 45% is present. This stems principally from the fact that for the outlined purpose of use in the windshield 4 of the vehicle, reflectivities of 100% are impermissible for safety reasons. For other applications where such safety aspects are not important, the volume-holographic gratings can certainly be designed to have a reflectivity of greater than 45%.

The holographic beam splitter 5 is designed for the predetermined viewing direction 7 with a predetermined viewing angle α₁ of 62.5° (relative to the normal 12 at the point where the normal 12 intersects the windshield 4). However, viewing directions 13 and 14 deviating therefrom may also occur, for which the individual volume-holographic gratings have different reflectivities since a viewing-angle-dependent reflection efficiency profile is present for each of the volume-holographic gratings, and is different for the individual volume-holographic gratings. This would have the effect that, for example, the perceptible virtual image has an increasing red cast with increasing angular deviation from the predetermined viewing angle. In the case of large exit pupils 6, as shown in FIGS. 1 and 2, these different viewing angles for the user are already present for different positions in the virtual image. In this regard, the predetermined viewing angle is only fulfilled when the image center is viewed. The viewing direction 13 or 14 may already be present at the image edge, such that the individual perceived virtual image would already have a red cast away from the image center.

The viewing directions 13 and 14 thus define an angular range around the predetermined viewing direction 7 for which at least one true-color projection of the virtual image into the exit pupil 6 should be present. This can involve e.g. a range of ±2° relative to the predetermined viewing angle α₁.

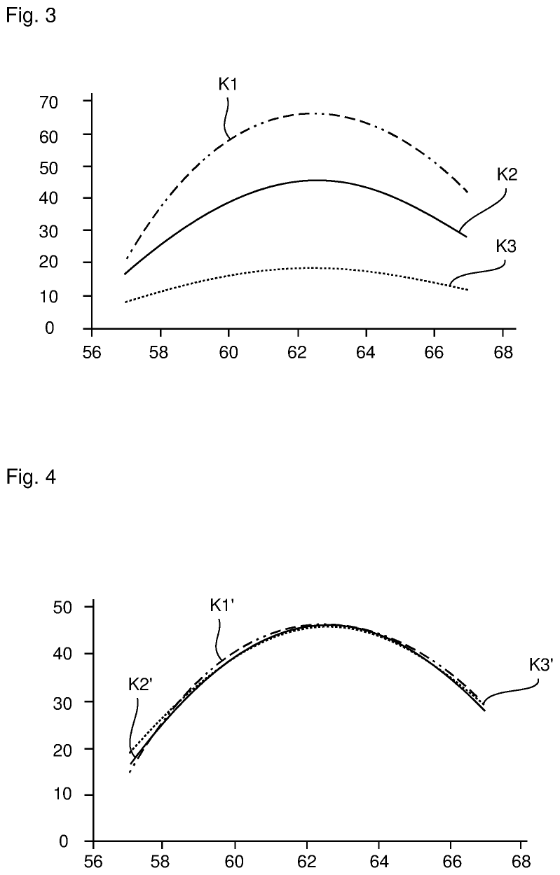

The individual volume-holographic gratings are configured for this purpose such that they have the diffraction efficiencies as a function of the viewing angle α as shown in FIG. 3, the viewing angle in degrees being plotted along the abscissa and the diffraction efficiency and thus the reflectivity in percent being plotted along the ordinate. The curve K1 shows the diffraction efficiency of the grating for 460 nm, the curve K2 shows the diffraction efficiency for the wavelength of 532 nm, and the curve K3 shows the diffraction efficiency for the wavelength of 640 nm. Each of the curves K1-K3 has its maximum at the predetermined viewing angle di of 62.5° and then falls in terms of the diffraction efficiency with increasing or decreasing viewing angle, such that the diffraction efficiency profiles shown in FIG. 3 are present. The fall is chosen, then, such that for each viewing angle the ratio of the diffraction efficiencies is equal to the ratio of the diffraction efficiencies at the predetermined viewing angle α₁. In the case of the example described in an exemplary way here, the diffraction efficiency for the predetermined viewing angle α₁ is 66.4% for the wavelength of 460 nm, 45.7% for the wavelength of 523 nm, and 18.8% for the wavelength of 640 nm. The diffraction efficiency adaptation is achieved by the volume-holographic gratings for the three wavelengths being written into a common material layer with the refractive index of 1.5 and a layer thickness of 10 μm with a refractive index modulation of 0.015 for 460 nm, 0.0125 for 532 nm, and 0.0085 for 640 nm. The diffraction efficiency profiles of the curves K1, K2 and K3 therefore have a ratio of 2.4:1:0.7.

In order then to attain a true-color projection, the control unit 9 controls the image generator 8 such that the brightnesses for the blue, green and red color sub-images are exactly inversely proportional to the described ratio of the curves K1-K3. The brightness ratio for the blue, green and red color sub-images is therefore 0.4:1:1.4, such that an effective reflectivity (i.e. with brightness correction) as shown schematically in FIG. 4 is present after the deflection at the holographic gratings in the photopolymer layer 11. In FIG. 4, the viewing angle in degrees is plotted along the ordinate and the diffraction efficiency taking account of the brightness correction in percent is plotted along the abscissa. The three curves K1′, K2′ and K3′ virtually lie one above another for the desired viewing angle range, such that a true-color projection of the virtual image is present. The user sees merely a certain fall in brightness with increasing distance from the center, but that is very much less disturbing than the color cast effect described.

As can furthermore be gathered from FIG. 4, the maximum reflectivity for the predetermined viewing angle α₁ is approx. 46%, and so the transmission is at least 54%.

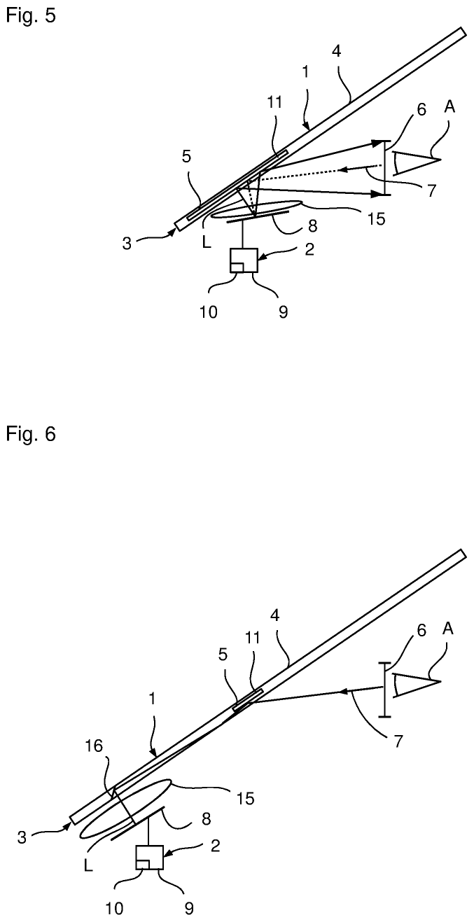

Of course, it is possible for the projection device 1 to comprise even further optical elements, for example for minimizing aberrations. In this regard, mirrors and lenses can be used. As illustrated schematically in FIG. 5, for example, an optical unit 15 comprising a plurality of optically effective surfaces can be arranged between the image generator 8 and the holographic beam splitter 5, with the optical unit 15 being depicted schematically here as a lens. This optical unit 15 is necessary for correcting optical aberrations, such as dynamic distortion, which inevitably occur in the depicted system from FIG. 1 during the imaging of the image generator 8 over the volume hologram 5 as solely effective surface. In this case, the volume hologram 5 can also be placed into the optical system 15 such that at the windshield 4 conventional Fresnel reflection is used for specularly reflecting the image into the driver's field of view. If the volume hologram is placed into the optical system 15, the diffraction efficiency of the volume hologram can the greater than 46%.

Furthermore, FIG. 6 shows a variation in which the light from the image generator 8 is coupled into the windshield 4 via a coupling element 16 (for example deflection mirror) and is guided therein by way of at least one reflection as far as the photopolymer layer 11, at which the described output coupling is carried out.

Instead of the windshield 4, any other transparent body can also be used for the projection device 1. This transparent body can be configured as a plane-parallel plate. However, it is also possible for at least one interface (for example front and/or rear side) to be configured in curved fashion.

The photopolymer layer 11 can be embedded in the transparent body, as shown with the windshield in FIGS. 1, 2, 5 and 6. However, it is also possible for the photopolymer layer to be formed on the front side or rear side of the transparent body. Furthermore, a capping layer can also provided on the photopolymer layer 11.

The projection device 1 can also be configured as being mountable on the user's head and for this purpose can comprise a holding device 32, which is mountable on the user's head and can be configured, for example, in the manner of a conventional spectacle frame. In this case, the projection device 1 can comprise a first and a second spectacle lens 33, 34, which are attached to the holding device 32. The holding device 32 with the spectacle lenses 33, 34 can be configured for example as sports goggles or spectacles, sunglasses, and/or spectacles for correcting defective vision, it being possible for the virtual image to be superposed onto the user's field of view via the first spectacle lens 33.

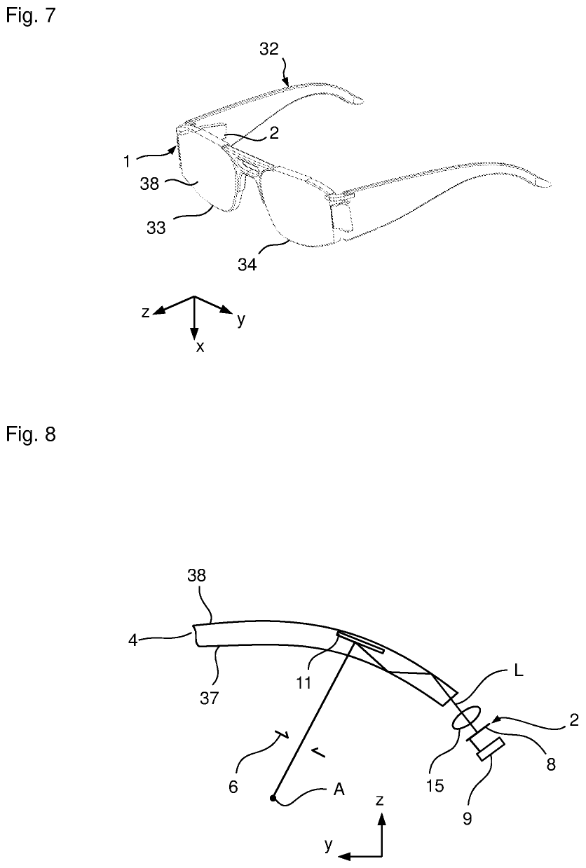

The image module 2 can be arranged in the region of the right eyeglass temple of the holding device 32, as illustrated schematically in FIG. 7.

As can be best seen from the enlarged, schematic partial sectional view in FIG. 8, the first spectacle lens 33 comprises a back side 37 and a front side 38. The back side 37 and the front side 38 are curved here. However, it is also possible that they are planar. The curvature can be a spherical curvature or an aspherical curvature.

If the virtual image is intended to be visible in a manner superimposed with the surroundings, an effective deflection efficiency in the range of, for example, 50% may again be present. If the surroundings are intended not to be visible, the deflection efficiency selected can be greater.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-8. (canceled)

9. A projection device, comprising:
an image module, which generates a multicolored image by generating a first color sub-image having a first wavelength and a second color sub-image having a second wavelength;
a projection unit, to which the multicolored image is fed and which images the image into an exit pupil such that an observer can perceive the image as a virtual image when an eye of the observer is positioned in the exit pupil and the observer looks at the projection unit at a predetermined viewing angle,
wherein the projection comprises a volume hologram, which deflects the multicolored image into the exit pupil for imaging purposes,
wherein the volume hologram comprises a volume grating for each wavelength of the color sub-images, the volume grating having a respective deflection efficiency profile which is dependent on the viewing angle and which is maximal for the predetermined viewing angle such that a first efficiency ratio of the first deflection efficiency profile for the first wavelength to the deflection efficiency profile of the second wavelength is present,
wherein the deflection efficiency profiles for a predetermined angular range around the predetermined viewing angle are set such that the first efficiency ratio for the predetermined angular range is constant, and
wherein the image module is controlled such that when the multicolored image is generated, a first brightness ratio of the brightness of the first color sub-image to the brightness of the second color sub-image is inversely proportional to the first efficiency ratio such that the different deflection efficiency profiles are compensated for and the observer can perceive the multicolored image as a true-color virtual image for viewing angles from the predetermined angular range.

10. The projection device of claim 9, wherein all the volume gratings are formed in a common layer.

11. The projection device of claim 9, wherein the volume gratings are configured as reflective volume gratings.

12. The projection device of claim 9, wherein the volume hologram is embedded in a transparent carrier.

13. The projection device of claim 9, wherein the projection unit comprises an image waveguide, in which the multicolored image is coupled and guided via reflection as far as the volume hologram, which causes the deflection of the multicolored image and hence the output coupling from the image waveguide.

14. The projection device of claim 9,
wherein the image module further generates a third color sub-image having a third wavelength, wherein on the basis of the deflection efficiency profile of the volume grating for the third wavelength, a second efficiency ratio of the first deflection efficiency profile for the first wavelength to the deflection efficiency profile of the third wavelength is present and the deflection efficiency profiles for the predetermined angular range around the predetermined viewing angle are set such that the second efficiency ratio for the predetermined angular range is constant, and
wherein the image module is controlled such that when the multicolored image is generated, a second brightness ratio of the brightness of the first color sub-image to the brightness of the third color sub-image is inversely proportional to the second efficiency ratio.

15. The projection device of claim 14, wherein the first wavelength lies in a blue wavelength range, the second wavelength lies in a green wavelength range, and the third wavelength lies in a red wavelength range.

16. A projection method, comprising:
generating a multicolored image by generation of a first color sub-image having a first wavelength and a second color sub-image having a second wavelength;
feeding the multicolored image to a projection unit, which images said image into an exit pupil such that an observer can perceive the image as a virtual image when an eye of the observer is positioned in the exit pupil and the observer looks at the projection unit at a predetermined viewing angle;
providing a volume hologram to the projection unit to deflect the multicolored image into the exit pupil for imaging purposes,
wherein the volume hologram has a volume grating for each wavelength of the color sub-images, said volume grating having a respective deflection efficiency profile which is dependent on the viewing angle and which is maximal for the predetermined viewing angle such that a first efficiency ratio of the first deflection efficiency profile for the first wavelength to the deflection efficiency profile of the second wavelength is present,
wherein the deflection efficiency profiles for a predetermined angular range around the predetermined viewing angle are set such that the first efficiency ratio for the predetermined angular range is constant; and
generating the multicolored image, wherein a first brightness ratio of the brightness of the first color sub-image to the brightness of the second color sub-image is inversely proportional to the first efficiency ratio such that the different deflection efficiency profiles are compensated for and the observer can perceive the multicolored image as a true-color virtual image for viewing angles from the predetermined angular range.
